(19) United States
(12) Patent Application Publication
(10) Pub. No.: US 2026/0303259 A1
(43) Pub. Date: Oct. 1, 2026

(54) APPENDING A SIDEBAND SIGNALING BIT TO A TRANSITION GROUP PATTERN

(71) Applicant: Microchip Technology Inc., Chandler, AZ (US)

(72) Inventor: Peter Graumann, Calgary (CA)

(73) Assignee: Microchip Technology Inc., Chandler, AZ (US)

(21) Appl. No.: 19/264,426

(22) Filed: Jul. 9, 2025

Related U.S. Application Data
(60) Provisional application No. 63/777,382, filed on Mar. 25, 2025.

(51) Int. Cl. H04L 1/00

(52) U.S. Cl. CPC H04L 1/006

(57) ABSTRACT

A system and method for providing additional sideband signaling using PAM5 convolution code modulation are disclosed. The method may include selecting a transition group pattern. The method may also include pulling a first sideband signaling bit on a first in, first out basis. The method may additionally include appending the first sideband signaling bit to the selected transition group pattern. The method may further include transmitting a first data stream containing the selected transition group pattern and the first sideband signaling bit.

### PRIORITY

This application claims priority to U.S. Provisional Patent Application No. 63/777,382 filed Mar. 25, 2025, the contents of which are hereby incorporated in their entirety.

### TECHNICAL FIELD

The present disclosure relates to high-speed communications, and in particular, to a system and method for providing additional sideband signaling using 5-level pulse amplitude modulation (PAM5) convolution code modulation.

### BACKGROUND

PAM5 (Quinary Pulse-Amplitude Modulation) is a modulation technique used in Serializer/Deserializer (SerDes) systems, specifically for high-speed data transmission. It utilizes five distinct signal levels to encode data, with each level representing a symbol. PAM5 may allow for a higher data rate compared to lower-order PAM schemes like PAM4, as each symbol can carry more information. PAM5 encodes data by varying the amplitude of a signal across five voltage levels. Specifically, each symbol is represented by one of five voltage levels (e.g., −2, −1, 0, +1, +2). This means that each symbol can represent two bits of data, effectively doubling the symbol rate compared to binary encoding. PAM5 allows for the transmission of more bits per symbol compared to other modulation schemes.

PAM5 may be combined with a form of convolutional coding to ensure reliable high-speed data transmission. Prior to PAM5 modulation, the digital data undergoes trellis encoding, a type of convolutional coding that adds redundancy to the signal. This redundancy is incorporated into the data stream, allowing the receiver to detect and correct errors introduced during transmission. The resulting encoded data is then modulated using PAM5, where five distinct voltage levels represent the encoded symbols. At the receiving end, the Viterbi algorithm effectively decodes the received PAM5 signal by leveraging the added redundancy from the trellis encoding, reducing the impact of noise and interference and ensuring accurate data recovery.

### SUMMARY OF THE INVENTION

Aspects provide systems and methods for providing additional sideband signaling using 5-level pulse amplitude modulation (PAM5) convolution code modulation. Examples of the present disclosure may include a method. The method may include selecting a transition group pattern. The method may also include pulling a first sideband signaling bit on a first in, first out basis. The method may additionally include appending the first sideband signaling bit to the selected transition group pattern. The method may further include transmitting a first data stream containing the selected transition group pattern and the first sideband signaling bit.

In combination with any of the above examples, selecting the transition group pattern may include selecting a plurality of transition group patterns. The number of selected transition group patterns may be based on a number of signaling levels of a modulation scheme used to transmit the first data stream.

In combination with any of the above examples, the method may include transmitting a second data stream containing an unselected transition group pattern. The second data stream may not contain a second sideband signaling bit.

In combination with any of the above examples, the transition group pattern may be a trellis representing signal levels of a modulation scheme.

In combination with any of the above examples, the modulation scheme may be PAM5.

Alone or in combination with any of the above examples, examples of the present disclosure may include an apparatus. The apparatus may include a sideband signaling circuit. The apparatus may also include an encoding circuit. The encoding circuit may be to select a transition group pattern. The encoding circuit may also be to pull a first sideband signaling bit on a first in, first out basis from the sideband signaling circuit. The encoding circuit may additionally be to append the first sideband signaling bit to the selected transition group pattern. The encoding circuit may further be to transmit a first data stream containing the selected transition group pattern and the first sideband signaling bit.

In combination with any of the above examples, selecting the transition group pattern may include selecting a plurality of transition group patterns. A number of selected transition group patterns may be based on a number of signaling levels of a modulation scheme used to transmit the first data stream.

In combination with any of the above examples, the encoding circuit may be to transmit a second data stream containing an unselected transition group pattern. The second data stream may not contain a second sideband signaling bit.

In combination with any of the above examples, the transition group pattern may be a trellis representing signal levels of a modulation scheme.

In combination with any of the above examples, the modulation scheme may be PAM5.

Alone or in combination with any of the above examples, examples of the present disclosure may include a method. The method may include receiving an incoming data stream. The method may also include extracting a transition group pattern and a sideband signaling bit from the incoming data stream. The method may additionally include pushing the sideband signaling bit on a first in, first out basis as a sideband signaling message. The method may further include decoding the transition group pattern.

In combination with any of the above examples, the sideband signaling message may be an asynchronous stream of information.

In combination with any of the above examples, the method may include receiving a second data stream containing a second transition group pattern. The second data stream may not contain a second sideband signaling bit.

In combination with any of the above examples, the transition group pattern may be a trellis representing signal levels of a modulation scheme.

In combination with any of the above examples, the modulation scheme is PAM5.

Alone or in combination with any of the above examples, examples of the present disclosure may include an apparatus. The apparatus may include a sideband signaling circuit. The apparatus may also include a decoding circuit. The decoding circuit may be to receive an incoming data stream. The decoding circuit may also be to extract a transition group pattern and a sideband signaling bit from the incoming data stream. The decoding circuit may additionally be to push the sideband signaling bit on a first in, first out basis as a sideband signaling message. The decoding circuit may further be to decode the transition group pattern.

In combination with any of the above examples, the sideband signaling message may be an asynchronous stream of information.

In combination with any of the above examples, the decoding circuit may be to receive a second data stream containing a second transition group pattern. The second data stream may not contain a second sideband signaling bit.

In combination with any of the above examples, the transition group pattern may be a trellis representing signal levels of a modulation scheme.

In combination with any of the above examples, the modulation scheme may be PAM5.

### BRIEF DESCRIPTION OF THE DRAWINGS

The figures illustrate examples of systems and methods providing additional sideband signaling using 5-level pulse amplitude modulation (PAM5) convolution code modulation.

FIG. 1 illustrates a block diagram of a system used to provide sideband signaling using PAM5 convolutional coding modulation, according to examples of the present disclosure;

FIG. 2 illustrates the encoding of PAM5 convolutional coding, according to examples of the present disclosure;

FIG. 3 illustrates a table of patterns, transmitted bits, and sideband signaling bits, according to examples of the present disclosure;

FIG. 4 illustrates a block diagram of an example system for providing sideband signaling using PAM5 convolution code modulation for PCIe communications, according to examples of the present disclosure;

FIG. 5 illustrates a method for encoding a sideband signaling bit into a data stream using PAM5 convolutional coding modulation, according to examples of the present disclosure; and

FIG. 6 illustrates a method for decoding a sideband signaling bit from a data stream using PAM5 convolutional coding modulation, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, systems and methods providing additional sideband signaling using 5-level pulse amplitude modulation (PAM5) convolution code modulation are provided. PAM5 convolutional code modulation uses 512 levels (e.g., 29 levels), however, 625 levels (e.g., 54 levels) are available using four consecutive PAM5 signals. Some of the unused levels may be used to provide a sideband signal in parallel with the original transmission over a communications channel. Therefore, the disclosed system and methods may provide a communication mechanism to provide an additional signaling path. The additional sideband signal may be used for any suitable application, such as link control, to increase the data rate of the serializer/deserializer (SerDes) link, or any combination thereof. The sideband signals may be provided at any suitable bandwidth, such as 1/64^{th} or 2/64^{th} of the bandwidth of the communication channel, up to 14/64^{th} of the bandwidth of the communication channel. Where the communication channel has a bandwidth of 128 gigabytes per second (GBps), the sideband signals may use an additional two or four Gbps of bandwidth. Using the disclosed systems and methods, protocol requirements (e.g., Gigabit Ethernet, peripheral component interconnect express (PCIe)) may be met while providing bandwidth for sideband signals.

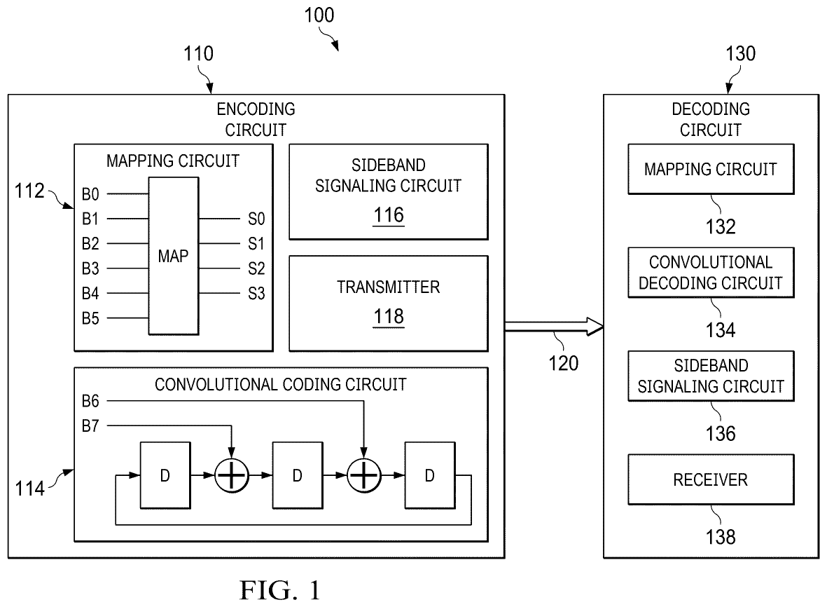

FIG. 1 illustrates a block diagram of a system used to provide sideband signaling using PAM5 convolutional coding modulation, according to examples of the present disclosure. System 100 may include encoding circuit 110 communicatively coupled via communication channel 120 to decoding circuit 130.

Encoding circuit 110 may include mapping circuit 112, convolutional coding circuit 114, sideband signaling circuit 116, and transmitter 118. Each of mapping circuit 112, convolutional coding circuit 114, and sideband signaling circuit 116 may be analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Each of mapping circuit 112, convolutional coding circuit 114, and sideband signaling circuit 116 may be implemented by instructions for execution by a processor through, for example, a function, application programming interface (API) call, script, program, compiled code, interpreted code, binary, executable, executable file, firmware, object file, container, assembly code, or object. For example, each of mapping circuit 112, convolutional coding circuit 114, and sideband signaling circuit 116 may be implemented by instructions stored in a non-transitory medium such as a memory that, when loaded and executed by a processor such as a central processing unit (CPU) (or any other suitable process), cause the functionality of each of mapping circuit 112, convolutional coding circuit 114, and sideband signaling circuit 116 described herein.

Convolution coding circuit 114 may be a finite state machine (FSM) with a limited amount of state (e.g., limited number of states). Convolution coding circuit 114 may produce output bits that are various functions of input bits and the previous state. After the output bits are produced, the FSM transitions to a new state based on the input bits and the previous state of convolution coding circuit 114.

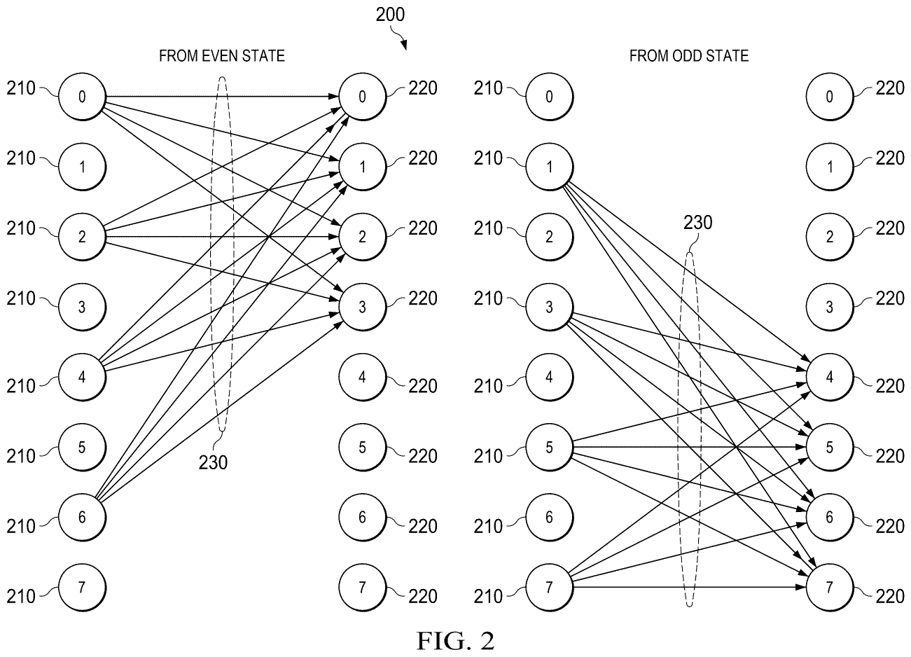

A trellis is a graphical representation of the FSM of convolution coding circuit 114 that illustrates the state transitions of convolution coding circuit 114 over time. FIG. 2 illustrates the encoding of PAM5 convolutional coding, according to examples of the present disclosure. The trellis includes a first set of nodes (depicted as circles 210 in FIG. 2) that represent possible states at a current time step, a second set of nodes (depicted as circles 220 in FIG. 2) that represent possible states at a next time step, and arcs (depicted as arrows 230 in FIG. 2) that connect nodes in the first set to nodes in the second set. Each node represents a specific state (e.g., identified by a number). Each arc represents a valid transition from one state to another state. Because the trellis contains eight states and six bits of information is encoded into the details of each transition, there may be sixty-four (64) different patterns available in each transition. Specifically, there may be eight different transition groups (TGs) of sixty-four different patterns. Four different TGs may be used from even numbered states and four different TGs may be used from odd numbered states. Thus, there is a total of 512 patterns (e.g., 8 TGs*64 patterns).

Convolution coding circuit 114 may be used by transmitter 118 to produce encoded output bits that are a function of a current input bit and one or more previous input bits that set the current state of convolution coding circuit 114. This effectively spreads the information of an input bit (the current input bit) over several output bits, which increases redundancy and the ability of receiver 138 to detect and correct errors that may occur during transmission via communication channel 120. The redundancy introduced by convolutional encoding allows a transmitted signal to be more resilient to the impairments of communication channel 120, such as noise, insertion loss, and interference.

Mapping circuit 112 may modulate the encoded output bits onto communication channel 120 using a modulation scheme, i.e., by mapping the encoded output bits to physical symbols that are transmitted on communication channel 120 (the transmitted symbols). For example, mapping circuit 112 may use pulse amplitude modulation (PAM) to encode data by varying amplitude of electrical pulses using multiple distinct signal levels. As a specific example, mapping circuit 112 may use PAM5 to encode data by varying the amplitude of a signal across five voltage levels. Each symbol is represented by one of five voltage levels (e.g., −2, −1, 0, +1, +2). The output of mapping circuit 112 may be a set of four PAM5 symbols (e.g., S0, S1, S2, and S3). S0 may be the first symbol to be transmitted and S3 may be the last symbol transmitted. Each PAM5 symbol may be one of five settings (e.g., −2, −1, 0, 1, or 2).

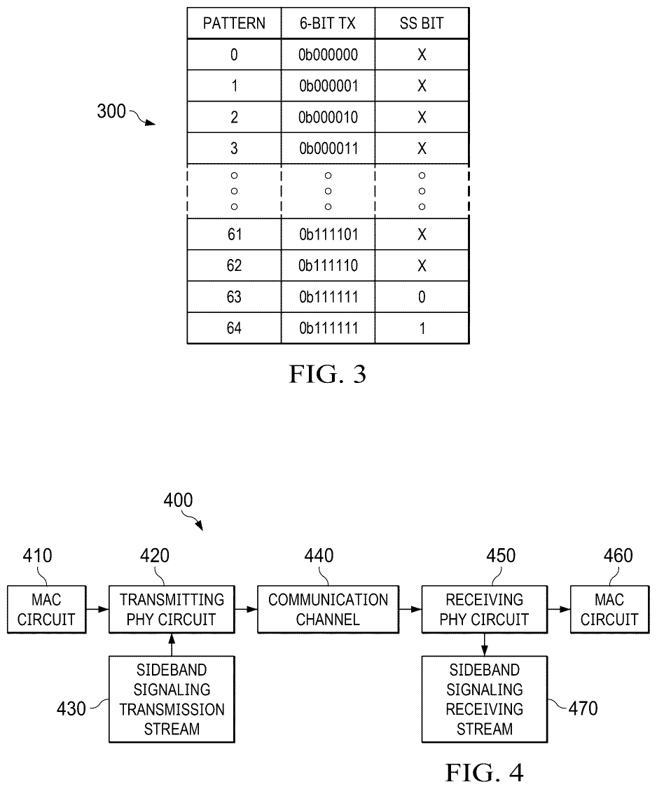

Sideband signaling circuit 116 may be communicatively coupled to mapping circuit 112 and may provide a sideband signaling bit to mapping circuit 112 to add to one or more patterns in selected transition groups. As an example, FIG. 3 illustrates a table of patterns, transmitted bits, and sideband signaling bits, according to examples of the present disclosure. In the example shown in FIG. 3, one additional pattern is added to the set of sixty-four patterns in the transition group, creating sixty-five patterns in the transition group. Specifically, patterns sixty-three and sixty-four have identical transmitted bit patterns and also include a sideband signaling bit, a “0” for pattern sixty-three and a “1” for pattern sixty-four. The other sixty three patterns do not include a sideband signaling bit. In the example shown in FIG. 3, where the transition group has sixty-five patterns instead of the standard sixty-four patterns, a total of 520 patterns (e.g., 8 TGs*65 patterns) of the available 625 patterns may be used.

The transition group may be increased to more than sixty-five patterns, up to a maximum of seventy-eight patterns (e.g., 8 TGs*78 patterns=624 total patterns). As additional patterns are added to the transition group, the sideband signaling may consume more of the bandwidth of communication channel 120. For example, where a single transition has sixty-five patterns, the sideband signaling may be 1/512^{th} of the bandwidth of communication channel 120 and where a single transition has sixty-six patterns, the sideband signaling may be 1/32^{nd} of the bandwidth of communication channel 120. At the maximum size of a transition group, seventy-eight patterns, the sideband signaling may be 14/64^{th} of the bandwidth of communication channel 120. In other examples, more than one transition group may have additional entries. For example, if eight transition groups have 65 entries, then the sideband signaling may have 1/64^{th} of the bandwidth of communication channel 120. As another example, if eight transition groups have 66 entries, then the sideband signaling may have 1/32^{th} of the bandwidth of communication channel 120.

Sideband signaling circuit 116 may provide the sideband signaling bit on a first-in-first-out (FIFO) basis. When a pattern is to be transmitted that includes a sideband signaling bit (e.g., transition pattern 63 or 64 shown in FIG. 3), mapping circuit 112 may pull a sideband signaling bit from sideband signaling circuit 116. Mapping circuit 112 may include the sideband signaling on an opportunistic basis (e.g., the timing of the transmission of a sideband signaling bit may be variable). For example, where one pattern is added to the transition group for sideband signaling (e.g., a 65-pattern transition group), a sideband signaling bit may be included in the transmitted bits only when the designated pattern is to be sent. Otherwise, no sideband signaling bit may be sent.

Communication channel 120 may be any suitable communication channel used for SerDes communication. For example, communication channel 120 may be a communication link found in high-speed communication systems such as data centers, networking equipment, and high-speed interfaces such as Peripheral Component Interconnect Express (PCIe) and Universal Serial Bus (USB).

Decoding circuit 130 may include mapping circuit 132, convolutional decoding circuit 134, sideband signaling circuit 136, and receiver 138. Each of mapping circuit 132, convolutional decoding circuit 134, and sideband signaling circuit 136 may be analog circuitry, digital circuitry, control logic, digital logic circuits programmed through hardware description language, ASICs, FPGAs, PLDs, or any suitable combination thereof, whether in a unitary device or spread over several devices. Each of mapping circuit 132, convolutional decoding circuit 134, and sideband signaling circuit 136 may be implemented by instructions for execution by a processor through, for example, a function, API call, script, program, compiled code, interpreted code, binary, executable, executable file, firmware, object file, container, assembly code, or object. For example, each of mapping circuit 132, convolutional decoding circuit 134, and sideband signaling circuit 136 may be implemented by instructions stored in a non-transitory medium such as a memory that, when loaded and executed by a processor such as a CPU (or any other suitable process), cause the functionality of each of mapping circuit 132, convolutional decoding circuit 134, and sideband signaling circuit 136 described herein.

Receiver 138 may be communicatively coupled to communication channel 120 and receive the sequence of bits from transmitter 118. Mapping circuit 132 may analyze a received sequence of bits and determine an input sequence of bits that best (most likely) explains the received sequence of bits. Stated another way, mapping circuit 132 and convolutional decoding circuit 134 may determine an input sequence of bits (e.g., an input sequence of bits fed to mapping circuit 132) that most likely produced the received sequence of bits. Referring to the trellis representation shown in FIG. 2, mapping circuit 132 may consider the finite number of possible states, and the most likely sequence that led to that state, using an algorithm such as the Viterbi algorithm and lookup tables in convolutional decoding circuit 134 that contain data about the previous state and new state.

Sideband signaling circuit 136 may be communicatively coupled to mapping circuit 132 and may receive sideband signaling bits pushed from mapping circuit 132 to sideband signaling circuit 136. Sideband signaling circuit 136 may output the sideband signaling bits on a FIFO basis. The output of sideband signaling circuit 136 may be an asynchronous stream of information in a sideband signaling message stream.

FIG. 4 illustrates a block diagram of an example system for providing sideband signaling using PAM5 convolution code modulation for PCIe communications, according to examples of the present disclosure. System 400 may include PCIe media access control (MAC) 410, transmitting physical layer interface (PHY) circuit 420, sideband signaling transmission stream 430, communication channel 440, receiving PHY circuit 450, PCIe MAC circuit 460, and sideband signaling receiving stream 470.

MAC circuit 410 and MAC circuit 460 may control access to communication channel 440. MAC circuit 410 may prepare data for transmission and ensure that the data conforms to protocol rules. On the transmitting side, MAC circuit 410 may format data packets into a frame, encode the frame, and schedule the frame for transmission. On the receiving side, MAC circuit 460 may decode received frames and check for transmission errors. After decoding the received frames, MAC circuit 460 may have two independent data streams, one data stream corresponding to the data packets from MAC circuit 410 and another data stream corresponding to sideband signaling transmission stream 430.

Transmitting PHY circuit 420 and receiving PHY circuit 450 may be the hardware used to transmit data signals over communication channel 440. Transmitting PHY circuit 420 may serialize a data frame from MAC circuit 410 and convert the frame into electrical signals. Transmitting PHY circuit 420 may include circuits for encoding a data stream using PAM5 convolutional code modulation, such as the component of encoding circuit 110 shown in FIG. 1. Receiving PHY circuit 450 may capture the incoming electrical signals and may deserialize the signals to reconstruct the digital frame. Receiving PHY circuit 450 may include circuits for decoding a data stream using PAM5 convolutional code modulation, such as the component of decoding circuit 130 shown in FIG. 1. Transmitting PHY circuit 420 and receiving PHY circuit 450 may be agnostic to protocol and signaling received from MAC circuit 410. The PAM5 convolutional code modulation performed by transmitting PHY circuit 420 and receiving PHY circuit 450 may be invisible to MAC circuit 410 and MAC circuit 460.

Transmitting PHY circuit 420 may be communicatively coupled to sideband signaling transmission stream 430. Sideband signaling transmission stream 430 may be converted into sideband signaling bits and included in the electrical signals sent by transmitting PHY circuit 420 to receiving PHY circuit 450 on a first in, first out basis, as described above with respect to sideband signaling circuit 116 shown in FIG. 1.

Receiving PHY circuit 450 may be communicatively coupled to sideband signaling receiving stream 470. Sideband signaling receiving stream 470 may receive sideband signaling bits included in the electrical signals sent by transmitting PHY circuit 420 to receiving PHY circuit 450 and converted to a sideband signaling stream on a first in, first out basis, as described above with respect to sideband signaling circuit 136 shown in FIG. 1.

Communication channel 440 may be any suitable communication channel, such as but not limited to PCIe generation 6 or PCIe generation 7. The data rate of the transmitted and received electrical signals may match the expectations of the PCIe protocol.

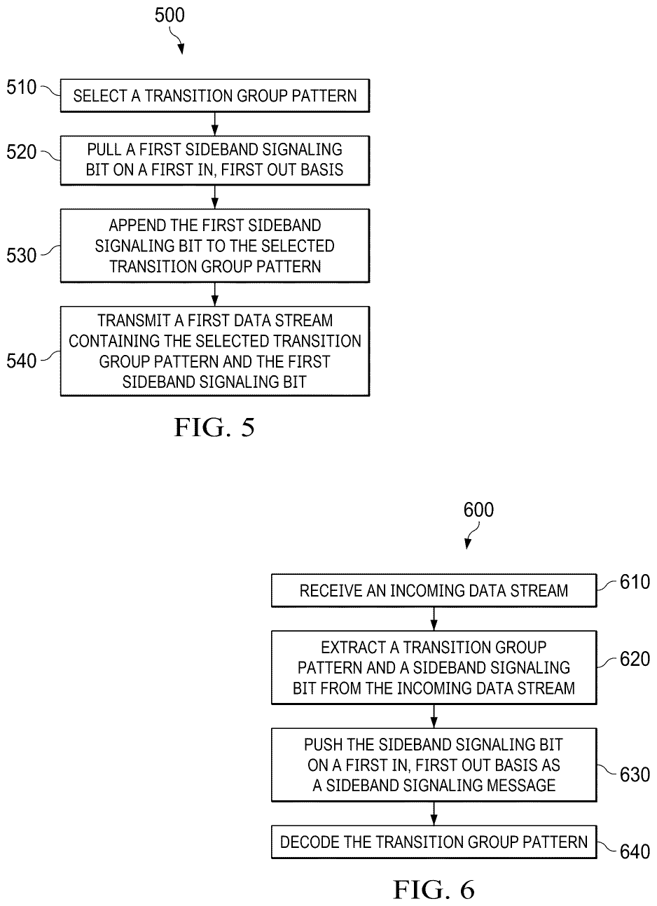

FIG. 5 illustrates a method for encoding a sideband signaling bit into a data stream using PAM5 convolutional coding modulation, according to examples of the present disclosure. Method 500 may be implemented by an encoding circuit, such as encoding circuit 110 shown in FIG. 1, including a mapping circuit, a convolutional coding circuit, a sideband signaling circuit, and a transmitter. Although examples have been described above, other variations and examples may be made from this disclosure without departing from the spirit and scope of these disclosed examples.

Method 500 may begin at block 510, where a transition group pattern may be selected. The transition group pattern may be from a trellis representing signal levels of a modulation scheme (e.g., a PAM5 modulation scheme). For example, the transition group pattern may include a set of four symbols, each symbol representing one of five voltage levels (e.g., −2, −1, 0, +1, +2). The selected transition group pattern may be the pattern to which a sideband signaling bit will be appended. For example, as shown in the example illustrated in FIG. 3, patterns 0b111111 may be selected transition group pattern and may have a sideband signaling bit appended to the pattern.

In some examples, more than one transition group pattern may be selected. For example, the standard sixty-four patterns may be increased by a single transition group pattern (e.g., to sixty-five patterns) up to a maximum of seventh-eight patterns. Seventy-eight patterns may be the maximum because the number of selected transition group patterns is based on a number of signaling levels of a modulation scheme used to transmit the data stream. Additionally, the number of transition groups that may have additional patterns may be between one and eight (because there are eight transition groups). An example of the progression of adding patterns to transition groups and the impact on the bandwidth is shown in Table 1. Table 1 is exemplary only and other combinations of the number of transition groups and patterns may be used.

TABLE 1

| | | Bandwidth (based on |
|---|---|---|
| Number of Transition | | bandwidth of the |
| Groups | Number of Patterns | communication channel) |
| 1 | 65 | 1/512 |
| 2 | 65 | 1/256 |
| 4 | 65 | 1/128 |
| 8 | 65 | 1/64 |
| 8 | 66 | 1/32 |

At block 520, a mapping circuit may pull a first sideband signaling bit on a first in, first out basis. The mapping circuit may pull the first sideband signaling bit from a sideband signaling circuit. The mapping circuit may pull the first sideband signaling bit from the sideband signaling circuit when the selected transition group is to be transmitted. If the selected transition group is not to be transmitted, the mapping circuit may not pull the first sideband signaling bit from the sideband signaling circuit.

Where multiple transition group patterns are selected at block 510, the mapping circuit may pull, on a first in, first out basis, a sideband signaling bit any time a selected transition group pattern is to be transmitted.

At block 530, the mapping circuit may append the first sideband signaling bit to the selected transition group pattern. The mapping circuit may add the first sideband signaling bit at the end of the transition group pattern. The sideband signaling bit may be a “0” or a “1.”

At block 540, the encoding circuit may transmit a first data stream containing the selected transition group pattern and the first sideband signaling bit. The first data stream may be transmitted on any suitable communication channel, such as, but not limited to, PCIe or USB. The encoding circuit may transmit the first data stream to a decoding circuit, such as decoding circuit 130 shown in FIG. 1.

The encoding circuit may also transmit data streams not containing the selected transmission group pattern. When transmitting a data stream not containing the selected transmission group pattern, the data stream may not include a sideband signaling bit.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

FIG. 6 illustrates a method for decoding a sideband signaling bit from a data stream using PAM5 convolutional coding modulation, according to examples of the present disclosure. Method 600 may be implemented by a decoding circuit, such as decoding circuit 130 shown in FIG. 1, including a mapping circuit, a convolutional decoding circuit, a sideband signaling circuit, and a receiver. Although examples have been described above, other variations and examples may be made from this disclosure without departing from the spirit and scope of these disclosed examples.

Method 600 may begin at block 610, where the decoding circuit may receive an incoming data stream. The decoding circuit may receive the incoming data stream from an encoding circuit, such as encoding circuit 110 shown in FIG. 1, via any suitable communication channel, such as, but not limited to, PCIe or USB.

In some examples, the incoming data stream may include a transition group pattern and a sideband signaling bit. The incoming data stream may include a sideband signaling bit when the transition group is a selected transition group as described with respect to block 510 of FIG. 5. In other examples, the incoming data stream may not include a sideband signaling bit such as when the transition group is not a selected transition group.

At block 620, the decoding circuit may extract a transition group pattern and a sideband signaling bit from the incoming data stream. The decoding circuit may separate the transition group pattern (e.g., a set of four symbols, each symbol representing one of five voltage levels (e.g., −2, −1, 0, +1, +2)) from the sideband signaling bit (e.g., a “0” or a “1”) appended to the end of the transition group pattern. The transition group pattern may be from a trellis representing signal levels of a modulation scheme (e.g., a PAM5 modulation scheme). For example, the transition group pattern may include a set of four symbols, each symbol representing one of five voltage levels (e.g., −2, −1, 0, +1, +2).

At block 630, the decoding circuit may push the sideband signaling bit, on a first in, first out basis, as a sideband signaling message. A mapping circuit of the decoding circuit may push the sideband signaling bit to a sideband signaling circuit, such as sideband signaling circuit 136 shown in FIG. 1. The sideband signaling circuit may use the sideband signaling bits to construct a sideband signaling message stream. The sideband signaling message stream may be an asynchronous stream of information.

At block 640, the decoding circuit may decode the transition group pattern. The decoding circuit may determine an input sequence of bits (e.g., an input sequence of bits fed to a mapping circuit of an encoding circuit) that most likely produced the received sequence of bits. The mapping circuit may consider the finite number of possible states, and the most likely sequence that led to that state, using an algorithm such as the Viterbi algorithm and lookup tables in a convolutional decoding circuit, such as convolutional decoding circuit 134 shown in FIG. 1, that contain data about the previous state and new state.

Although FIG. 6 discloses a particular number of operations related to method 600, method 600 may be executed with greater or fewer operations than those depicted in FIG. 6. In addition, although FIG. 6 discloses a certain order of operations to be taken with respect to method 600, the operations comprising method 600 may be completed in any suitable order.

Although examples have been described above, other variations and examples may be made from this disclosure without departing from the spirit and scope of these disclosed examples.

1. A method, comprising:
selecting a transition group pattern;
pulling a first sideband signaling bit on a first in, first out basis;
appending the first sideband signaling bit to the selected transition group pattern; and
transmitting a first data stream containing the selected transition group pattern and the first sideband signaling bit.

2. The method of claim 1, wherein:
selecting the transition group pattern includes selecting a plurality of transition group patterns; and
the number of selected transition group patterns is based on a number of signaling levels of a modulation scheme used to transmit the first data stream.

3. The method of claim 1, comprising transmitting a second data stream containing an unselected transition group pattern; and
wherein the second data stream does not contain a second sideband signaling bit.

4. The method of claim 1, wherein the transition group pattern is a trellis representing signal levels of a modulation scheme.

5. The method of claim 4, wherein the modulation scheme is PAM5.

6. An apparatus, comprising:
a sideband signaling circuit; and
an encoding circuit, the encoding circuit to:
select a transition group pattern;
pull a first sideband signaling bit on a first in, first out basis from the sideband signaling circuit;
append the first sideband signaling bit to the selected transition group pattern; and
transmit a first data stream containing the selected transition group pattern and the first sideband signaling bit.

7. The apparatus of claim 6, wherein:
selecting the transition group pattern includes selecting a plurality of transition group patterns; and
a number of selected transition group patterns is based on a number of signaling levels of a modulation scheme used to transmit the first data stream.

8. The apparatus of claim 6, wherein:
the encoding circuit is to transmit a second data stream containing an unselected transition group pattern; and
the second data stream does not contain a second sideband signaling bit.

9. The apparatus of claim 6, wherein the transition group pattern is a trellis representing signal levels of a modulation scheme.

10. The apparatus of claim 9, wherein the modulation scheme is PAM5.

11. A method, comprising:
receiving an incoming data stream;
extracting a transition group pattern and a sideband signaling bit from the incoming data stream;
pushing the sideband signaling bit on a first in, first out basis as a sideband signaling message; and
decoding the transition group pattern.

12. The method of claim 11, wherein the sideband signaling message is an asynchronous stream of information.

13. The method of claim 11, comprising receiving a second data stream containing a second transition group pattern, wherein the second data stream does not contain a second sideband signaling bit.

14. The method of claim 11, wherein the transition group pattern is a trellis representing signal levels of a modulation scheme.

15. The method of claim 14, wherein the modulation scheme is PAM5.

16. An apparatus, comprising:
a sideband signaling circuit; and
a decoding circuit, the decoding circuit to:
receive an incoming data stream;
extract a transition group pattern and a sideband signaling bit from the incoming data stream;
push the sideband signaling bit on a first in, first out basis as a sideband signaling message; and
decode the transition group pattern.

17. The apparatus of claim 16, wherein the sideband signaling message is an asynchronous stream of information.

18. The apparatus of claim 16, wherein the decoding circuit is to receive a second data stream containing a second transition group pattern, wherein the second data stream does not contain a second sideband signaling bit.

19. The apparatus of claim 16, wherein the transition group pattern is a trellis representing signal levels of a modulation scheme.

20. The apparatus of claim 19, wherein the modulation scheme is PAM5.
